(19) United States
(12) Patent Application Publication
(10) Pub. No.: US 2013/0285885 A1
(43) Pub. Date: Oct. 31, 2013

(54) HEAD-MOUNTED LIGHT-FIELD DISPLAY

(71) Applicants: Andreas G. Nowatzyk, San Jose, CA (US); Rod G. Fleck, Bellevue, WA (US)

(72) Inventors: Andreas G. Nowatzyk, San Jose, CA (US); Rod G. Fleck, Bellevue, WA (US)

(21) Appl. No.: 13/719,334

(22) Filed: Dec. 19, 2012

Related U.S. Application Data
(63) Continuation of application No. 13/707,429, filed on Dec. 6, 2012, now abandoned.
Application No. 13/707,429 is a continuation of application No. 13/455,150, filed on Apr. 25, 2012, now abandoned.

(51) Int. Cl. G09G 5/00

(52) U.S. Cl. CPC G09G 5/00
USPC 345/8

(57) ABSTRACT

A head-mounted light-field display system (HMD) includes two light-field projectors (LFPs), one per eye, each comprising a solid-state LED emitter array (SLEA) operatively coupled to a microlens array (MLA). The SLEA and the MLA are positioned so that light emitted from an LED of the SLEA reaches the eye through at most one microlens from the MLA. The HMD's LFP comprises a moveable solid-state LED emitter array coupled to a microlens array for close placement in front of an eye—without the need for any additional relay or coupling optics—wherein the LED emitter array physically moves with respect to the microlens array to mechanically multiplex the LED emitters to achieve resolution via mechanically multiplexing.

### CROSS-REFERENCE TO RELATED APPLICATIONS

This application is a continuation of U.S. patent application Ser. No. 13/707,429 “HEAD-MOUNTED LIGHT-FIELD DISPLAY,” filed Dec. 6, 2012, which is a continuation of U.S. patent application Ser. No. 13/455,150, “HEAD-MOUNTED LIGHT-FIELD DISPLAY,” filed Apr. 25, 2012, the contents of which are hereby incorporated by reference in their entirety.

### BACKGROUND

Three-dimensional (3-D) displays are useful for many purposes including vision research, operation of remote devices, medical imaging, surgical training, scientific visualization, and virtual prototyping, and many other virtual- and augmented-reality applications by rendering a faithful impression of the 3-D structure of the portrayed object in the light-field. A 3-D display enhances viewer perception of depth by stimulating stereopsis, motion parallax, and other optical cues. Stereopsis provides different images to each eye of the user such that retinal disparity indicates simulated depth of objects within the image. Motion parallax, in contrast, changes the images viewed by the user as a function of the changing position of the user over time, which again simulates depth of the objects within the image. However, current 3-D displays (such as, for example, a head-mounted display (HMD)) present two slightly different two-dimensional (2-D) images for each eye at a fixed focus distance regardless of the intended distance of the shown objects. If the distance of the presented object differs from the focus distance of the display, then the depth cues from parallax also differ from the focus cues causing the eye to either focus at the wrong distance or the object to appear to be out of focus. Prolonged discrepancies between focus cues and other depth cues can contribute to user discomfort. Indeed, a primary cause of the distortions is that typical 3-D displays present one or more images on a two-dimensional (2-D) surface where the user cannot help but focus on the depth cues provided by the physical 2-D surface itself instead of the depth cues suggested by the virtual objects portrayed in the images of the depicted scene.

Head-mounted displays (HMDs) are a useful and promising form for 3-D displays for a variety of applications. While early HMDs used miniature CRT displays, more modern HMDs use a variety of display technologies such as Liquid Crystal On Silicon (LCOS), MEMS scanners, OLED, or DLPs. However, HMD devices still remain large and expensive and often provide only a limited field of view (i.e., 40 degrees). Moreover, like other 3-D displays, HMDs typically do not support focus cues and show images in a frame sequential fashion where temporal lag (or latency) occurs between user head motion and the display of corresponding visual cues. Discrepancies between user head orientation, optical focus cues, and stereoscopic images can be uncomfortable for the user and may result in motion sickness and other undesirable side-effects. In addition, HMDs are often difficult to use by people having vision deficiencies that use prescription eye glasses. These shortcomings, in turn, have been attributed with limiting the acceptance of HMD based virtual/augmented reality systems.

### SUMMARY

Head-mounted display systems producing stereoscopic images are more effective when they provide a large field of view with high resolution and support correct optical focus cues to enable the user's eyes to focus on the displayed objects as if those objects are located at the intended distance from the user. Discrepancies between optical focus cues and stereoscopic images can be uncomfortable for the user and may result in motion sickness and other undesirable side-effects, and thus correct optical focal cues are used to create a truer three-dimensional effect and minimize side-effects. In addition, head-mounted display systems correct for imperfect vision and account for eye prescriptions (including corrections for astigmatism).

An HMD is described that provides a relatively large field of view featuring high resolution and correct optical focus cues that enable the user's eyes to focus on the displayed objects as if those objects are located at the intended distance from the user. Several such implementations feature lightweight designs that are compact in size, exhibit high light efficiency, use low power consumption, and feature low inherent device costs. Certain implementations adapt to the imperfect vision (e.g., myopia, astigmatism, etc.) of the user.

Various implementations disclosed herein are further directed to a head-mounted light-field display system (HMD) that renders an enhanced stereoscopic light-field to each eye of a user. The HMD includes two light-field projectors (LFPs), one per eye, each comprising a solid-state LED emitter array (SLEA) operatively coupled to a microlens array (MLA) and positioned in front of each eye. The SLEA and the MLA are positioned so that light emitted from an LED of the SLEA reaches the eye through at most one microlens from the MLA. Several such implementations are directed to an HMD LFP comprising a moveable solid-state LED emitter array coupled to a microlens array for close placement in front of an eye—without the use of any additional relay or coupling optics—wherein the LED emitter array physically moves with respect to the microlens array to mechanically multiplex the LED emitters to achieve desired resolution.

Various implementations are also directed to “mechanically multiplexing” a much smaller (and more practical) number of LEDs—approximately 250,000—to time sequentially produce the effect of a dense 177 million LED array. Mechanical multiplexing may be achieved by moving the relative position of the LED light emitters with respect to the microlens array and increases the effective resolution of the display device without increasing the number of LEDs by effectively utilizing each LED to produce multiple pixels comprising the resultant display image. Hexagonal sampling may also increase and maximize the spatial resolution of 2D optical image devices.

This summary is provided to introduce a selection of concepts in a simplified form that are further described below in the detailed description. This summary is not intended to identify key features or essential features of the claimed subject matter, nor is it intended to be used to limit the scope of the claimed subject matter.

### BRIEF DESCRIPTION OF THE DRAWINGS

The foregoing summary, as well as the following detailed description of illustrative implementations, is better understood when read in conjunction with the appended drawings. For the purpose of illustrating the implementations, there is shown in the drawings example constructions of the implementations; however, the implementations are not limited to the specific methods and instrumentalities disclosed. In the drawings:

FIG. 1 is a side-view illustration of an implementation of a light-field projector (LFP) for a head-mounted light-field display system (HMD);

FIG. 2 is a side-view illustration of an implementation of a LFP for a head-mounted light-field display system (HMD) shown in FIG. 1 and featuring multiple primary beams forming a single pixel;

FIG. 3 illustrates how light is processed by the human eye for finite depth cues;

FIG. 4 illustrates an exemplary implementation of the LFP of FIGS. 1 and 2 used to produce the effect of a light source emanating from a finite distance;

FIG. 5 illustrates an exemplary SLEA geometry for certain implementations disclosed herein;

FIG. 6 is a block diagram of an implementation of a display processor that may be utilized by the various implementations described herein;

FIG. 7 is an operational flow diagram for utilization of a LFP by the display processor of FIG. 6 in a head-mounted light-field display device (HMD) representative of various implementations described herein;

FIG. 8 is an operational flow diagram for the mechanical multiplexing of a LFP by the display processor of FIG. 6; and

FIG. 9 is a block diagram of an example computing environment that may be used in conjunction with example implementations and aspects.

### DETAILED DESCRIPTION

For various implementations disclosed herein, the HMD comprises two light-field projectors (LFPs), one for each eye, that in turn comprise a solid-state LED emitter array (SLEA) and the microlens array (MLA) comprising a plurality of microlenses having a uniform diameter (e.g., approximately 1 mm). The SLEA comprises a plurality of solid state light emitting diodes (LEDs) that are integrated onto a silicon based chip having the logic and circuitry used to drive the LEDs. The SLEA is operatively coupled to the MLA such that the distance between the SLEA and the MLA is equal to the focal length of the microlenses comprising the MLA. This enables light rays emitted from a specific point on the surface of the SLEA (corresponding to an LED) to be focused into a “collimated” (or ray-parallel) beam as it passes through the MLA 120. Thus, light from one specific point source will result in one collimated beam that will enter the eye, the collimated beam having a diameter approximately equal to the diameter of the microlens through which it passed.

In a solid-state LED array, the light emission aperture can be designed to be relatively small compared to the pixel pitch which, in contrast to other display arrays, allows the integration of substantially more logic and support circuitry per pixel. With the increased logic and support circuitry, solid-state LEDs may be used for fast image generation (including, for certain implementations, fast frameless image generation) based on the measured head attitude of the HMD user in order to reduce and minimize latency between physical head motion and the generated display image. Minimized latency, in turn, reduces the onset of motion sickness and other negative side-effects of HMDs when used, for example, in virtual or augmented reality applications. In addition, focus cues consistent with the stereoscopic depth cues inherent to computer-generated 3-D images may also be added directly to the generated light field. It should be noted that solid state LEDs can be driven very fast, setting them apart from OLED and LCOS based HMDs. Moreover, while DPL-based HMDs can also be very fast, they are relatively expensive and thus solid-state LEDs present a more economical option for such implementations.

To achieve a large field of view without magnification components or relay optics, display devices are placed close to the user's eyes. For example, a 20 mm display device positioned 15 mm in front of each eye could provide a stereoscopic field of view of approximately 66 degrees.

FIG. 1 is a side-view illustration of an implementation of a light-field projector (LFP) 100 for a head-mounted light-field display system (HMD). The LFP 100 is at a set eye distance 104 away from the eye 130 of the user. The LFP 100 comprises a solid-state LED emitter array (SLEA) 110 and a microlens array (MLA) 120 operatively coupled such that the distance between the SLEA and the MLA (referred to as the microlens separation 102) is equal to the focal length of the microlenses comprising the MLA (which, in turn, produce collimated beams). The SLEA 110 comprises a plurality of solid state light emitting diodes (LEDs), such as LED 112 for example, that are integrated onto a silicon based chip (not shown) having the logic and circuitry needed to drive the LEDs. Similarly, the MLA 120 comprises a plurality of microlenses, such as microlenses 122a, 122b, and 122c for example, having a uniform diameter (e.g., approximately 1 mm). It should be noted that the particular components and features shown in FIG. 1 are not shown to scale with respect to one another. It should be noted that, for various implementations disclosed herein, the number of LEDs comprising the SLEA is one or more orders of magnitude greater than the number of lenses comprising the MLA, although only specific LEDs may be emitting at any given time.

The plurality of LEDs (e.g., LED 112) of the SLEA 110 represents the smallest light emission unit that may be activated independently. For example, each of the LEDs in the SLEA 110 may be independently controlled and set to output light at a particular intensity at a specific time. While only a certain number of LEDs comprising the SLEA 110 are shown in FIG. 1, this is for illustrative purposes only, and any number of LEDs may be supported by the SLEA 110 within the constraints afforded by the current state of technology (discussed further herein). In addition, because FIG. 1 represents a side-view of a LFP 100, additional columns of LEDs in the SLEA 110 are not visible in FIG. 1.

Similarly, the MLA 120 may comprise a plurality of microlenses, including microlenses 122a, 122b, and 122c. While the MLA 120 shown comprises a certain number of microlenses, this is also for illustrative purposes only, and any number of microlenses may be used in the MLA 120 within the constraints afforded by the current state of technology (discussed further herein). In addition, as described above, because FIG. 1 is a side-view of the LFP 100, there may be additional columns of microlenses in the MLA 120 that are not visible in FIG. 1. Further, the microlenses of the MLA 120 may be packed or arranged in a triangular, hexagonal or rectangular array (including a square array).

In operation, each LED of the SLEA 110, such as LED 112, may emit light from an emission point of the LED 112 and diverge toward the MLA 120. As these light emissions pass through certain microlenses, such as microlens 122b for example, the light emission for this microlens 122b is collimated and directed toward to the eye 130, specifically, toward the aperture of the eye defined by the inner edge of the iris 136. As such, the portion of the light emission 106 collimated by the microlens 122b enters the eye 130 at the cornea 134 and is converged into a single point or pixel 140 on the retina 132 at the back of the eye 130. On the other hand, as the light emissions from the LED 112 pass through certain other microlenses, such as microlens 122a and 122c for example, the light emission for these microlens 122a and 122c is collimated and directed away from the eye 130, specifically, away from the aperture of the eye defined by the inner edge of the iris 136. As such, the portion of the light emission 108 collimated by the microlens 122a and 122c does not enter the eye 130 and thus is not perceived by the eye 130. It should also be noted that the focal point for the collimated beam 106 that enters the eye is perceived to emit from an infinite distance. Furthermore, light beams that enter the eye from the MLA 120, such as light beam 106, is a “primary beam,” and light beams that do not enter the eye from the MLA 120 are “secondary beams.”

Since LEDs emit light in all directions, light from each LED may illuminate multiple microlenses in the MLA. However, for each individual LED, the light passing through only one of these microlens is directed into the eye (through the entrance aperture of the eye's pupil) while the light passing through other microlenses is directed away from the eye (outside the entrance aperture of the eye's pupil). The light that is directed into the eye is referred to herein as a primary beam while the light directed away from the eye is referred to herein as a secondary beam. The pitch and focal length of the plurality of microlenses comprising the microlens array are used to achieve this effect. For example, if the distance between the eye and the MLA (the eye distance 104) is set to be 15 mm, the MLA would need lenses about 1 mm in diameter and having a focal length of 2.5 mm. Otherwise, secondary beams might be directed into the eye and produce a “ghost image” displaced from but mimicking the intended image.

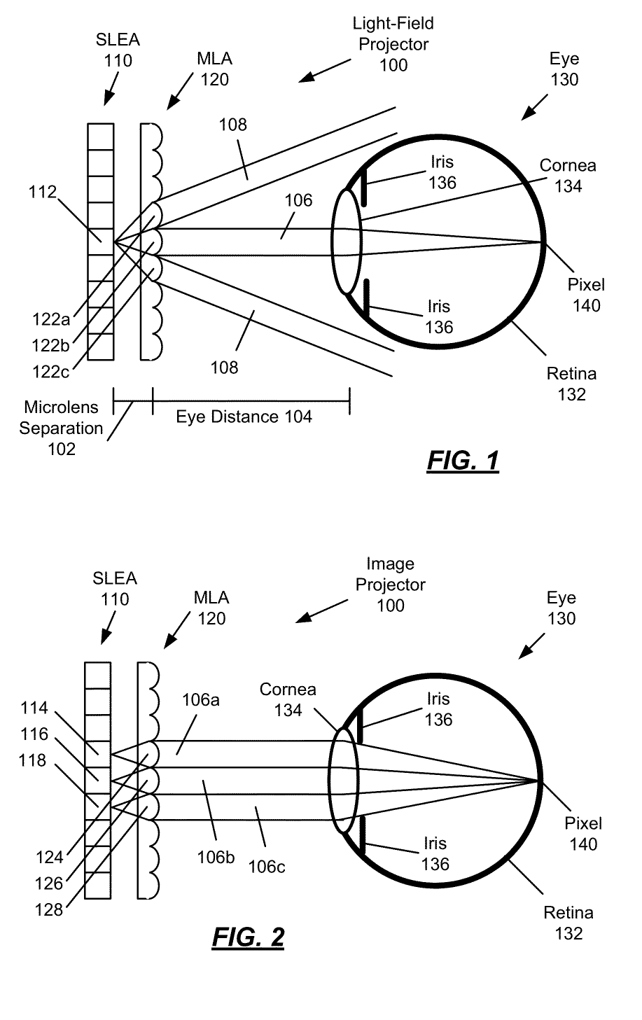

FIG. 2 is a side-view illustration of an implementation of a LFP 100 for a head-mounted light-field display system (HMD) shown in FIG. 1 and featuring multiple primary beams 106a, 106b, and 106c forming a single pixel 140. As shown in FIG. 2, light beams 106a, 106b, and 106c are emitted from the surface of the SLEA 110 at points respectively corresponding to three individual LEDs 114, 116, and 118 comprising the SLEA 110. As shown, the emission point of the LEDs comprising the SLEA 110—including the three LEDs 114, 116, and 118—are separated from one another by a distance equal to the diameter of each microlens, that is, the lens-to-lens distance (the “microlens array pitch” or simply “pitch”).

Since the LEDs in the SLEA 110 have the same pitch (or spacing) as the plurality of microlenses comprising the MLA 120, the primary beams passing through the MLA 120 are parallel to each other. Thus, when the eye is focused towards infinity, the light from the three emitters converges (via the eye's lens) onto a single spot on the retina and is thus perceived by the user as a single pixel located at an infinite distance. Since the pupil diameter of the eye varies according to lighting conditions but is generally in the range of 3 mm to 9 mm, the light from multiple (e.g., ranging from about 7 to 81) individual LEDs can be combined to produce the one pixel 140.

As illustrated in FIGS. 1 and 2, the MLA 120 may be positioned in front of the SLEA 110, and the distance between the SLEA 110 and the MLA 120 is referred to as the microlens separation 102. The microlens separation 102 may be chosen such that light emitting from each of the LEDs comprising the SLEA 110 passes through each of the microlenses of the MLA 120. The microlenses of the MLA 120 may be arranged such that light emitted from each individual LED of the SLEA 110 is viewable by the eye 130 through only one of the microlenses of the MLA 120. While light from individual LEDs in the SLEA 110 may pass through each of the microlenses in the MLA 120, the light from a particular LED (such as LED 112 or 116) may only be visible to the eye 130 through at most one microlens (122b and 126 respectively).

For example, as illustrated in FIG. 2, a light beam 106b emitted from a first LED 116 is viewable through the microlens 126 by the eye 130 at the eye distance 112. Similarly, light 106a from a second LED 114 is viewable through the microlens 124 at the eye 130 at the eye distance 112, and light 106c from a third LED 118 is viewable through the microlens 128 at the eye 130 at the eye distance 112. While light from the LEDs 114, 116, and 118 passes through the other microlenses in the MLA 120 (not shown), only the light 106a, 106b, and 106c from LEDs 114, 116, and 118 that pass through the microlenses 114, 116, and 118 are visible to the eye 130. Moreover, since individual LEDs are generally monochromatic but do exist in each of the three primary colors, each of these LEDs 114, 116, and 118 may correspond to three different colors, for example, red, green, and blue respectively, and these colors may be emitted in differing intensities to blend together at the pixel 140 to create any resultant color desired. Alternatively, other implementations may use multiple LED arrays that have specific red, green, and blue arrays that would be placed under, for example, four SLA (2×2) elements. In this configuration, the outputs would be combined at the eye to provide color at, for example, the 1 mm level versus the 10 μm level produced within the LED array. As such, this approach may save on sub-pixel count and reduce color conversion complexity for such implementations.

Of course, for certain implementations, the SLEA may not necessarily comprise RGB LEDs because, for example, red LEDs require a different manufacturing process; thus, certain implementations may comprise a SLEA that includes only blue LEDs where green and red light is produced from blue light via conversion, for example, using a layer of fluorescent material such as quantum dots.

It should be noted, however, that the implementation illustrated in FIGS. 1 and 2 does not support augmented reality applications where a projected image is superimposed on a view of the real world. Instead, the implementation specifically described in these figures provides only a generated display image. Nevertheless, alternative implementations of the HMD illustrated in FIGS. 1 and 2 may be implemented for augmented reality. For example, for certain augmented reality applications the image produced by an SLEA 110 may be projected onto a semi-transparent mirror having properties similar to the MLA 120 but with the added feature of enabling the user to view the real world through the mirror. Likewise, other implementations for implementing an augmented reality application may use a video camera integrated with the HMD to combine synthetic image projection with the real world video display. These and other such variations are several alternate implementations to those described herein.

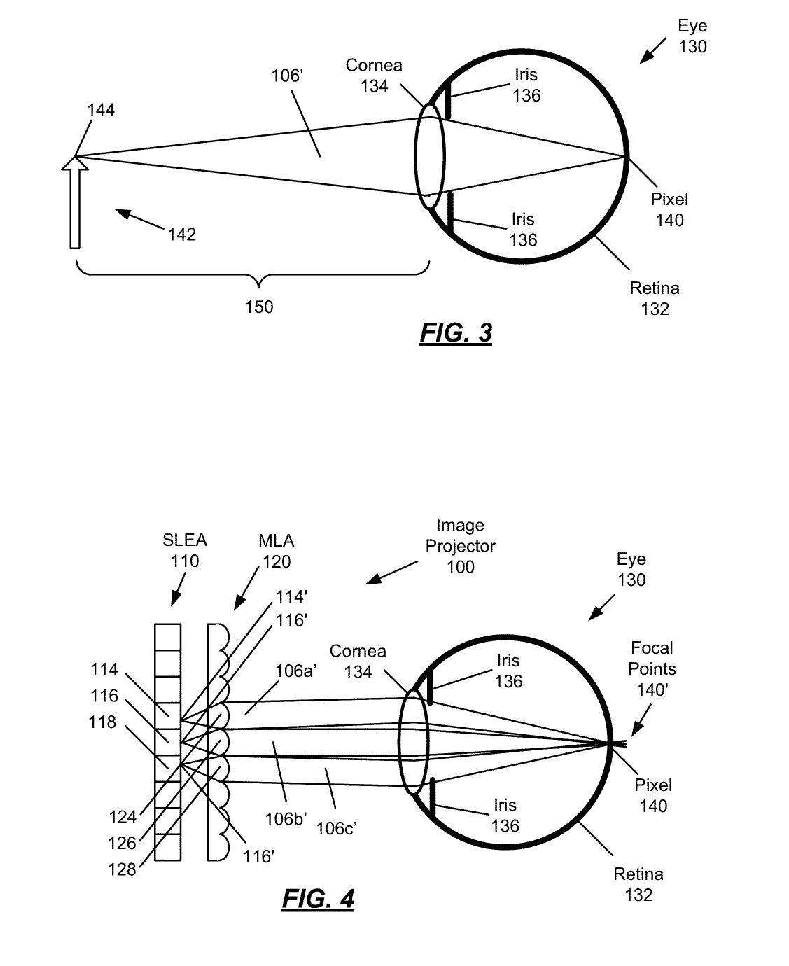

In the implementations described in FIGS. 1 and 2, the collimated primary beams (e.g., 106a, 106b, and 106c) together paint a pixel on the retina of the eye 130 of the user that is perceived by that user as emanating from an infinite distance. However, finite depth cues are used to provide a more consistent and comprehensive 3-D image. FIG. 3 illustrates how light is processed by the human eye 130 for finite depth cues, and FIG. 4 illustrates an exemplary implementation of the LFP 100 of FIGS. 1 and 2 used to produce the effect of a light source emanating from a finite distance.

As shown in FIG. 3, light 106′ that is emitted from the tip (or “point”) 144 of an object 142 at a specific distance 150 from the eye will have a certain divergence (as shown) as it enters the pupil of the eye 130. When the eye 130 is properly focused for the object's 142 distance 150 from the eye 130, the light from that one point 144 of the object 142 will then be converged onto a single image point 140 (or pixel corresponding to a photo-receptor in one or more cone-cells) 140 on the retina 132. This “proper focus” provides the user with depth cues used to judge the distance 150 to the object 142.

In order to approximate this effect, and as illustrated in FIG. 4, a LFP 100 produces a wavefront of light with a similar divergence at the pupil of the eye 130. This is accomplished by selecting the LED emission points 114′, 116′, and 118′ such that distances between these points are smaller than the MLA pitch (as opposed to equal to the MLA pitch in FIGS. 1 and 2 for a pixel at infinite distance). When the distances between these LED emission points 114′, 116′, and 118′ are smaller than the MLA pitch, the resulting primary beams 106a′, 106b′, and 106c′ are still individually collimated but are no longer parallel to each other; rather they diverge (as shown) to meet in one point (or pixel) 140 on the retina 132 given the focus state of the eye 130 for the corresponding finite distance depth cue. Each individual beam 114′, 116′, and 118′ is still collimated because the display chip to MLA distance has not changed. The net result is a focused image that appears to originate from an object at the specific distance 150 rather than infinity. It should be noted, however, that while the light 106a′, 106b′, and 106c′ from the three individual MLA lenses 124, 126, and 128 (that is, the center of each individual beam) intersect at a single point 140 on the retina, the light from each of the three individual MLA lenses do not individually converge in focus on the retina because the SLEA to MLA distance has not changed. Instead, the focal points 140′ for each individual beam lie beyond the retina.

The ability of the HMD to generate focus cues relies on the fact that light from several primary beams are combined in the eye to form one pixel. Consequently, each individual beam contributes only about 1/10 to 1/40 of the pixel intensity, for example. If the eye is focused at a different distance, the light from these several primary beams will spread out and appear blurred. Thus, the practical range for focus depth cues for these implementations uses the difference between the depth of field (DOF) of the human eye using the full pupil and the DOF of the HMD but with the entrance aperture reduced to the diameter of one beam. To illustrate this point, consider the following examples:

First, with an eye pupil diameter of 4 mm and a display angular resolution of 2 arc-minutes, the geometric DOF extends from 11 feet to infinity if the eye is focused on an object at a distance of 22 feet. There is a diffraction-based component to the DOF, but under these conditions, the geometric component will dominate. Conversely, a 1 mm beam would increase the DOF to range from 2.7 feet to infinity. In other words, if the operating range for this display device is set to include infinity at the upper DOF range limit, then the operating range for the disclosed display would begin at about 33 inch in front of the user. Displayed objects that are rendered to appear closer than this distance would begin to appear blurred even if the user properly focuses on them.

Second, the working range of the HMD may be shifted to include a shortened operating range at the expense of limiting the upper operating range. This may be done by slightly decreasing the distance between the SLEA and the MLA. For example, adjusting the MLA focus for a 3 feet mean working distance would produce correct focus cues in the HMD over the range of 23 inch to 6.4 feet. It therefore follows that it is possible to adjust the operating range of the HMD by including a mechanism that can adjust the distance between the SLEA and the MLA so that the operating range can be optimized for the use of the HMD. For example, game playing may render object at long distances (buildings, landscapes) while instructional material for fixing a PC or operating on a patient would show mostly nearby objects.

The HMD for certain implementations may also adapt to imperfections of the eye 130 of the user. Since the outer surface (cornea 134) of the eye contributes most of the image-forming refraction of the eye's optical system, approximating this surface with piecewise spherical patches (one for each beam of the wavefront display) can correct imperfections such as myopia and astigmatism. In effect, the correction can be translated into the appropriate surface, which then yields the angular correction for each beam to approximate an ideal optical system.

For some implementations, light sensors (photodiodes) may be embedded into the SLEA 110 to sense the position of each beam on the retina from the light that is reflected back towards the SLEA (akin to a “red-eye effect”). Adding photodiodes to the SLEA is readily achievable in terms of IC integration capabilities because the pixel-to-pixel distance is large and provides ample room for the photodiode support circuitry. With this embedded array of light sensors, it becomes possible to measure the actual optical properties of the eye and correct for lens aberrations without the need for a prescription from a prior eye examination. This mechanism would work if some light is emitted by the HMD. Depending on how sensitive the photodiodes are, alternate implementations could rely on some minimal background illumination for dark scenes, suspend adaptation when there is insufficient light, use a dedicated adaptation pattern at the beginning of use, and/or add an IR illumination system.

Monitoring the eye precisely measures the inter-eye distance and the actual orientation of the eye in real-time that yields information for improving the precision and fidelity of computer-generated 3D scenes. Indeed, perspective and stereoscopic image pair generation use an estimate of the observer's eye positions, and knowing the actual orientation of each eye may provide a cue to software as to which part of a scene is being observed.

With regard to various implementations disclosed herein, however, it should be noted that the MLA pitch is unrelated to the resulting resolution of the display device because the MLA itself is not positioned in an image plane. Instead, the resolution of this display device is dictated by how precise the direction of the beams can be controlled and how tightly these beams are collimated.

Smaller LEDs produce higher resolution. For example, a MLA focal length of 2.5 mm and an LED emission aperture of 1.5 micrometers in diameter would yield a geometric beam divergence of 2.06 arc-minutes or about twice the human eye's angular resolution. This would produce a resolution equivalent to an 85 DPI (dots per inch) display at a viewing distance of about 20 inches. Over a 66 degree field of view, this is equivalent to a width of 1920 pixels. In other words, in two-dimensions this configuration would result in a display of almost four million pixels and exceed current high-definition television (HDTV) standards. Based on these parameters, however, the SLEA would need to have an active area of about 20 mm by 20 mm completely covered with 1.5 micrometer sized light emitters—that is, a total of about 177 million LEDs. However, such a configuration is impractical for several reasons including the fact that there would be no room between LEDs for the needed wiring or drive electronics.

To overcome this, various implementations disclosed herein are directed to “mechanically multiplexing” approximately 250,000 LEDs to time sequentially produce the effect of a dense 177 million LED array. This approach exploits both the high efficiency and fast switching speeds featured by solid state LEDs. In general, LED efficiency favors small devices with high current densities resulting in high radiance, which in turn allows the construction of a LED emitter where most light is produced from a small aperture. Red and green LEDs of this kind have been produced for over a decade for fiber-optic applications, and high-efficiency blue LEDs can now be produced with similarly small apertures. A small device size also favors fast switching times due to lower device capacitance, enabling LEDs to turn on and off in a few nanoseconds while small specially-optimized LEDs can achieve sub-nanosecond switching times. Fast switching times allow one LED to time sequentially produce the light for many emitter locations. While the LED emission aperture is small for the proposed display device, the emitter pitch is under no such restriction. Thus, the LED display chip is an array of small emitters with enough room between LEDs to accommodate the drive circuitry.

Stated differently, in order to achieve the resolution, the LEDs of the display chip are multiplexed to reduce the number of actual LEDs on the chip down to a practical number. At the same time, multiplexing frees chip surface area that is use for the driver electronics and perhaps photodiodes for the sensing functions as discussed earlier. Another reason that favors a sparse emitter array is the ability to accommodate three different, interleaved sets of emitter LEDs, one for each color (red, green and blue), which may use different technologies or additional devices to convert the emitted wavelength to a particular color.

For certain implementations, each LED emitter may be used to display as many as 721 pixels (a 721:1 multiplexing ratio) so that instead of having to implement 177 million LEDs, the SLEA uses approximately 250,000 LEDs. While the factor of 721 is derived from increasing a hexagonal pixel to pixel distance by a factor of 15 (i.e., a 15× pitch ratio, that is, the ratio between the number of points in two hexagonal arrays is 3*n*(n+1)+1 where n is the number of point omitted between the points of the coarser array). Other multiplexing ratios are possible depending on the available technology constraints. Nevertheless, a hexagonal arrangement of pixels seemingly offers the highest possible resolution for a given number of pixels while mitigating aliasing artifacts. Therefore, implementations discussed herein are based on a hexagonal grid, although quadratic or rectangular grids may be used as well and nothing herein is intended to limit the implementations disclosed to only hexagonal grids. Furthermore, it should be noted that the MLA structure and the SLEA structure do not need to use the same pattern. For example, a hexagonal MLA may use a display chip with a square array, and vice versa. Nevertheless, hexagons are seemingly better approximations to a circle and offer improved performance for the MLA.

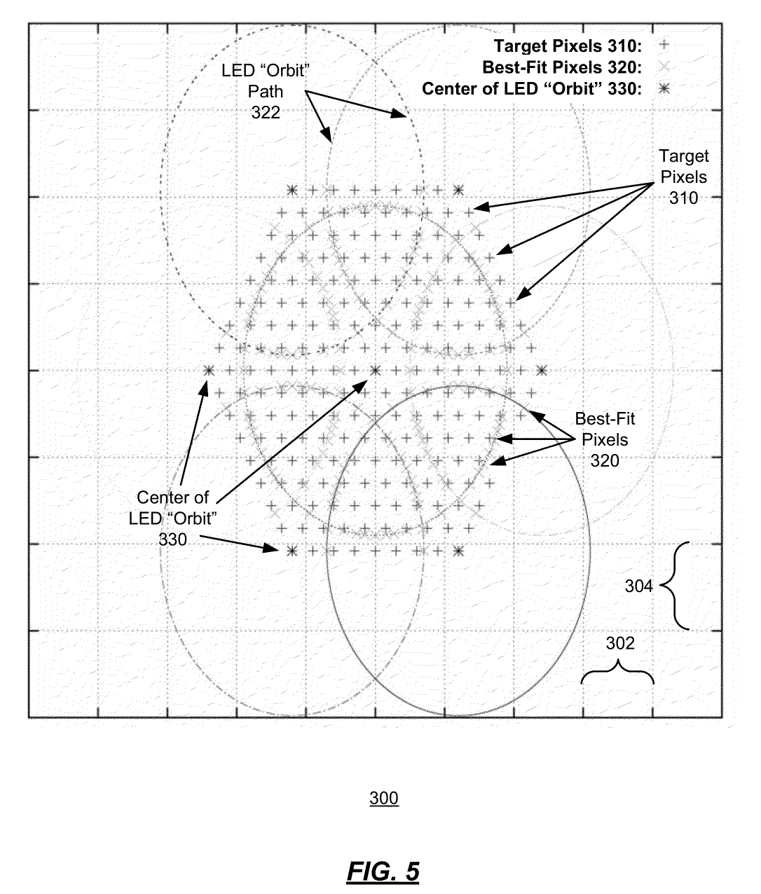

FIG. 5 illustrates an exemplary SLEA geometry for certain implementations disclosed herein. In the figure—and superimposed on a grid featuring increments on the X-axis 302 and the Y-axis 304 are 5 micrometers—the SLEA geometry features an 8×pitch ratio (in contrast to the 15×pitch ratio described above) which corresponds to the distance between two center of LED “orbits” 330 measured as a number of target pixels 310 (i.e., each center of LED orbit 330 is spaced eight target pixels 310 apart). In the figure, the target pixels 310 denoted by a plus sign (“+”) indicate the location of a desired LED emitter on the display chip surface representative of the arrangement of the 177 million LED configuration discussed above. In this exemplary implementation, the distance between each target pixel is 1.5 micrometers (consistent with providing HDTV fidelity, as previously discussed). The stars (similar to “*”) are the center of each LEDs “orbit” 330 (discussed below) and thus represents the presence of an actual physical LED, and the seven LEDs shown are used to simulate the desired LEDs for each target pixel 310. While each LED may emit light from an aperture with a 1.5 micrometer diameter, these LEDs are spaced 12 micrometers apart in the FIG. 22.5 micrometers apart for the 15×pitch ratio discussed above). Given that contemporary integrated circuit (IC) geometries use 22 nm to 45 nm transistors, this provides sufficient spacing between the LEDs for circuits and other wiring.

In such implementations represented by the configuration of FIG. 5, the SLEA and the MLA are mechanically moved with respect to each other to effect an “orbit” for each actual LED. In certain specific implementations, this is done by moving the SLEA, moving the MLA, or moving both simultaneously. Regardless of implementation, the displacement for the movement is small—on the order of about 30 micrometers—which is less than the diameter of a human hair. Moreover, the available time for one scan cycle is about the same as one frame time for a conventional display, that is, a one hundred frames-per-second display will require one hundred scan-cycles-per-second. This is readily achievable since moving an object with a weight of a fractional gram a distance of less than the diameter of a human hair one hundred times per second does not require much energy and can be done easily using either piezoelectric or electromagnetic actuators for example. For certain implementations, capacitive or optical sensors can be used in the drive system to stabilize this motion. Moreover, since the motion is strictly periodic and independent of the displayed image content, an actuator may use a resonant system which saves power and avoids vibration and noise. In addition, while there may be a variety of mechanical and electro-mechanical methodologies for moving the array anticipated by various implementations described herein, alternative implementations that employ a liquid crystal matrix (LCM) between the SLEA and MLA to provide motion are also anticipated and hereby disclosed.

FIG. 5 further illustrates the multiplexing operation using a circular scan trajectory represented by the circles labeled as LED “orbit” paths 322. For such implementations, the actual LED's are illuminated during their orbits when they are closest to the desired position—shown by the best-fit pixels 320 “X”-symbols in the figure—of the target pixels 310 that the LED is supposed to render. While the approximation is not particularly good in this particular configuration (as is evident by the fact that many “X” symbols are a bit far from the “+” target pixels 310 locations); however, the approximation improves with increases to the diameter of the scan trajectory.

When calculating the mean and maximal position error for a 15×pitch configuration as a function of the magnitude of mechanical displacement, it becomes evident that a circular scan path is not optimal. Instead, a Lissajous curve—which is generated if the sinusoidal deflection in the x and y direction occur with different frequencies—seemingly offers a greatly reduced error, and thus sinusoidal deflection is often chosen because it arises naturally from a resonant system. For example, the SLEA may be mounted on an elastic flex stage (e.g., a tuning fork) that moves in the X-direction while the MLA is attached to a similar elastic flex stage that moves in the perpendicular Y-direction. Assuming a 3:5 frequency ratio, which in the context of a one hundred frames-per-second system would mean that the stages operate at 300 Hz and 500 Hz (or any multiple thereof). Indeed, these frequencies are practical for a system that only uses deflection of a few sub-micrometers as the 3:5 Lissajous trajectory would have a worst case position error of 0.97 micrometers and a mean position error of only 0.35 micrometers when operated with a deflection of 34 micrometers.

Alternative implementations may utilize variations on how the scan movement could be implemented. For example, for certain implementations, an approach would be to rotate the MLA in front of the display chip. Such an approach has the property that the angular resolution increases along the radius extending outward from the center of rotation, which is helpful because the outer beams benefit more from higher resolution.

It should also be noted that solid state LEDs are among the most efficient light sources today, especially for small high-current-density devices where cooling is not a problem because the total light output is not large. An LED with an emitting area equivalent to the various SLEA implementations described herein could easily blind the eye at a mere 15 mm distance in front of the pupil if it were fully powered (even without focusing optics), and thus only low-power light emissions are used. Moreover, since the MLA will focus a large portion of the LED's emitted light directly into the pupil, the LEDs use even less current than normal. In addition, the LEDs are turned on for very short pulses to achieve what the user will perceive as a bright display. Decreasing the overall display brightness prevents contraction of the pupil which would otherwise increase the depth of field of the eye and thereby reduce the effectiveness of optical depth cues. Instead, various implementations disclosed herein use a range of relatively low light intensities to increase the “dynamic range” of the display to show both very bright and very dark objects in the same scene.

The acceptance of HMDs has been limited by their tendency to induce motion sickness, a problem that is commonly attributed to the fact that visual cues are constantly integrated by the human brain with the signals from the proprioceptive and the vestibular systems to determine body position and maintain balance. Thus, when the visual cues diverge from the sensation of the inner ear and body movement, users become uncomfortable. This problem has been recognized in the field for over 20 years, but there is no consensus on how much lag can be tolerated. Experiments have shown that a 60 milliseconds latency is too high, and a lower bound has not yet been established because most currently available HMDs still have latencies higher than 60 milliseconds due to the time needed by the image generation pipeline using available display technology.

Nevertheless, various implementations disclosed herein overcome this shortcoming due to the greatly enhanced speed of the LED display and faster update rate. This enables attitude sensors in the HMD to determine the user's head position in less than 1 millisecond, and this attitude data may then be used to update the image generation algorithm accordingly. In addition, the proposed display may be updated by scanning the LED display such that changes are made simultaneously over the visual field without any persistence, an approach different from other display technologies. For example, while pixels continuously emit light in a LCOS display, their intensity is adjusted periodically in a scan-line fashion which gives rise to tearing artifacts for fast moving scenes. In contrast, various implementations disclosed herein feature fast (and for certain implementations frameless) random update of the display. (As known and appreciation by those skilled in the art, frameless rendering reduces motion artifacts, which in conjunction with a low latency position update could mitigate the onset of virtual reality sickness).

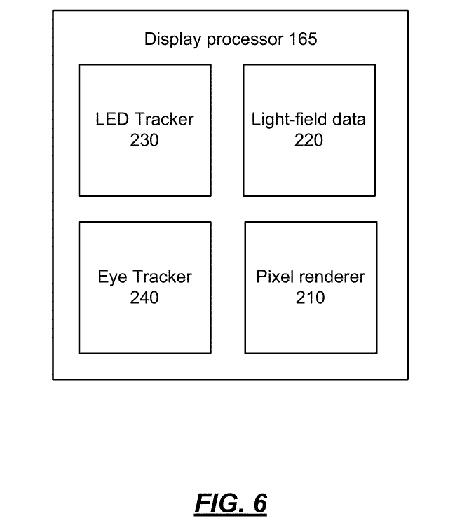

FIG. 6 is a block diagram of an implementation of a display processor 165 that may be utilized by the various implementations described herein. A display processor 165 may track the location of the in-motion LED apertures in the LFP 100, the location for each microlens in the MLA 120, adjust the output of the LEDs comprising the SLEA, and process data for rendering the desired light-field. The light-field may be a 3-D image or scene, for example, and the image or scene may be part of a 3-D video such as a 3-D movie or television broadcast. A variety of sources may provide the light-field to the display processor 165.

The display processor 165 may track and/or determine the location of the LED apertures in the LFP 100. In some implementations, the display processor 165 may also track the location of the aperture formed by the iris 136 of the eyes 130 using location and/or tracking devices associated with the eye tracking. Any system, method, or technique known in the art for determining a location may be used.

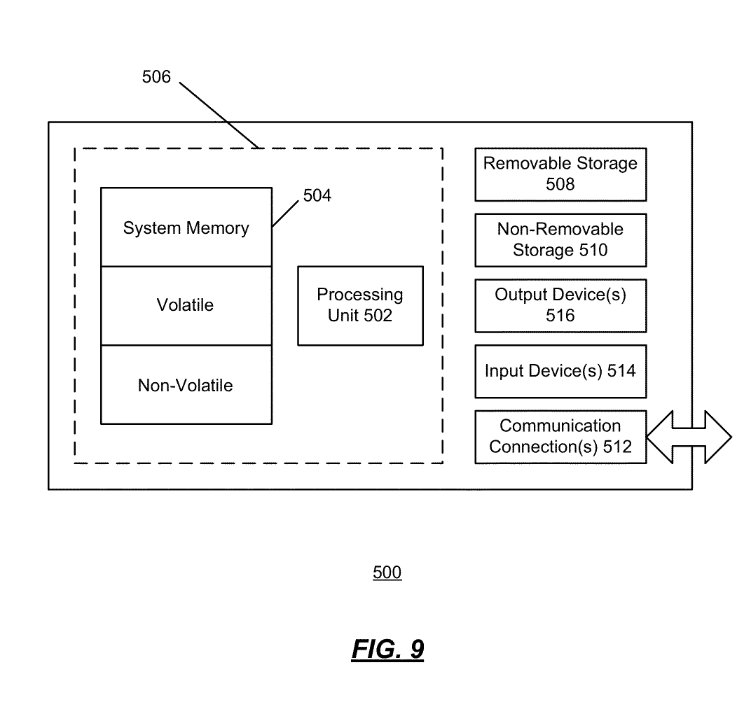

The display processor 165 may be implemented using a computing device such as the computing device 500 described below with respect to FIG. 9. The display processor 165 may include a variety of components including an eye tracker 240. The display processor 165 may further include a LED tracker 230 as previously described. The display processor 165 may also comprise light-field data 220 that may include a geometric description of a 3-D image or scene for the LFP 100 to display to the eyes of a user. In some implementations, the light-field data 220 may be a stored or recorded 3-D image or video. In other implementations, the light-field data 220 may be the output of a computer, video game system, or set-top box, etc. For example, the light-field data 220 may be received from a video game system outputting data describing a 3-D scene. In another example, the light-field data 220 may be the output of a 3-D video player processing a 3-D movie or 3-D television broadcast.

The display processor 165 may comprise a pixel renderer 210. The pixel renderer 210 may control the output of the LEDs so that a light-field described by the light-field data 220 is displayed to a viewer of the LFP 100. The pixel renderer 210 may use the output of the LED tracker 230 (i.e., the pixels that are visible through each individual microlens of the MLA 120 at the viewing apertures 140a and 140b) and the light-field data 220 to determine the output of the LEDs that will result in the light-field data 220 being correctly rendered to a viewer of the LFP 100. For example, the pixel renderer 210 may determine the appropriate position and intensity for each of the LEDs to render a light-field corresponding to the light-field data 220.

For example, for opaque scene objects, the color and intensity of a pixel may be determined by the pixel renderer 210 by determining by the color and intensity of the scene geometry at the intersection point nearest the target pixel. Computing this color and intensity may be done using a variety of known techniques.

In some implementations, the pixel renderer 210 may stimulate focus cues in the pixel rendering of the light-field. For example, the pixel renderer 210 may render the light-field data to include focus cues such as accommodation and the gradient of retinal blur appropriate for the light-field based on the geometry of the light-field (e.g., the distances of the various objects in the light-field) and the display distance 112. Any system, method, or techniques known in the art for stimulating focus cues may be used.

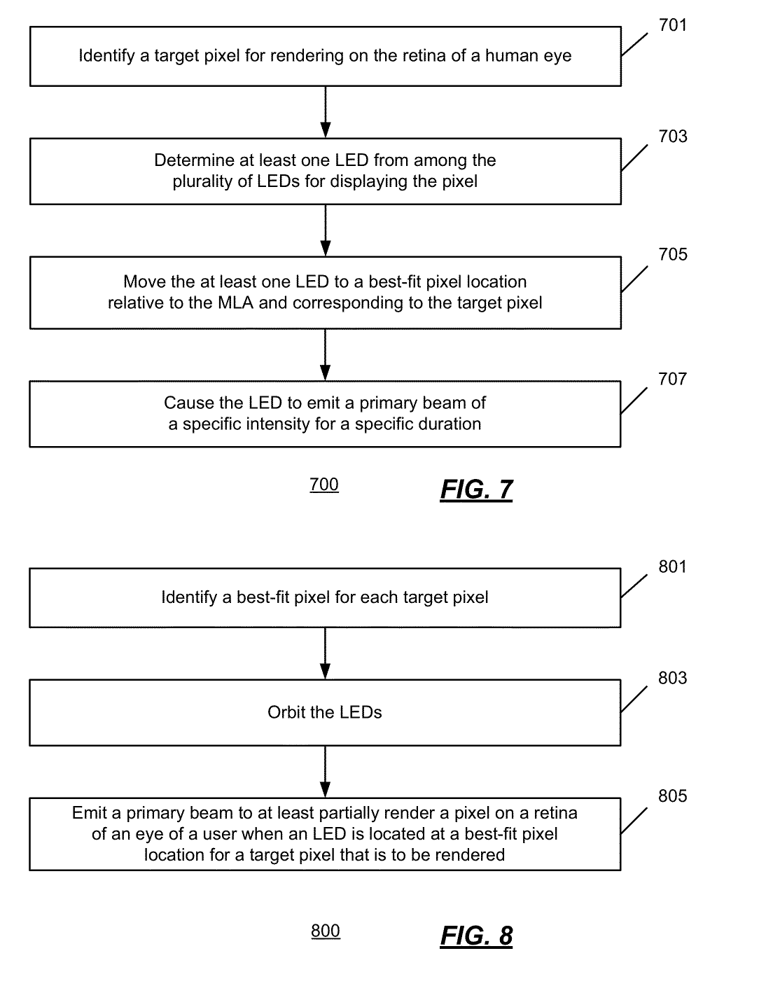

FIG. 7 is an operational flow diagram 700 for utilization of a LFP by the display processor 165 of FIG. 6 in a head-mounted light-field display device (HMD) representative of various implementations described herein. At 701, the display process 165 identifies a target pixel for rendering on the retina of a human eye. At 703, the display process determines at least one LED from among the plurality of LEDs for displaying the pixel. At 705, the display processor moves the at least one LED to a best-fit pixel 320 location relative to the MLA and corresponding to the target pixel and, at 707, the display process causes the LED to emit a primary beam of a specific intensity for a specific duration.

FIG. 8 is an operational flow diagram 800 for the mechanical multiplexing of a LFP by the display processor 165 of FIG. 6. At 801, the display processor 165 identifies a best-fit pixel for each target pixel. At 803, the processor orbits the LEDs and, at 805, emits a primary beam to at least partially render a pixel on a retina of an eye of a user when an LED is located at a best-fit pixel location for a target pixel that is to be rendered.

It should be further noted that while the concepts and solutions presented herein have been described in the context of use with an HMD, other alternative implementations are also anticipated by this disclosure such as for general use in projection solutions. For example, various implementations described herein may be used to simply increase the resolution of a display system having smaller MLA (i.e., lens) to SLEA (i.e., LED) ratios. In one such implementation, an 8×by 8×solution could be achieved using smaller MLA elements (on the order of 10 um to 50 um in contrast to 1 mm) where the motion of the array allows greater resolution. Of course, certain benefits of such implementations may be lost (such as focus) while providing other benefits (such as increased resolution). In addition, alternative implementations might also project the results of an electrically moved array into a light guide solution to enable augmented reality (AR) applications.

FIG. 9 is a block diagram of an example computing environment that may be used in conjunction with example implementations and aspects. The computing system environment is only one example of a suitable computing environment and is not intended to suggest any limitation as to the scope of use or functionality.

Numerous other general purpose or special purpose computing system environments or configurations may be used. Examples of well-known computing systems, environments, and/or configurations that may be suitable for use include, but are not limited to, personal computers (PCs), server computers, handheld or laptop devices, multiprocessor systems, microprocessor-based systems, network PCs, minicomputers, mainframe computers, embedded systems, distributed computing environments that include any of the above systems or devices, and the like.

Computer-executable instructions, such as program modules, being executed by a computer may be used. Generally, program modules include routines, programs, objects, components, data structures, etc. that perform particular tasks or implement particular abstract data types. Distributed computing environments may be used where tasks are performed by remote processing devices that are linked through a communications network or other data transmission medium. In a distributed computing environment, program modules and other data may be located in both local and remote computer storage media including memory storage devices.

With reference to FIG. 9, an exemplary system for implementing aspects described herein includes a computing device, such as computing device 500. In its most basic configuration, computing device 500 typically includes at least one processing unit 502 and memory 504. Depending on the exact configuration and type of computing device, memory 504 may be volatile (such as random access memory (RAM)), non-volatile (such as read-only memory (ROM), flash memory, etc.), or some combination of the two. This most basic configuration is illustrated in FIG. 9 by dashed line 506.

Computing device 500 may have additional features/functionality. For example, computing device 500 may include additional storage (removable and/or non-removable) including, but not limited to, magnetic or optical disks or tape. Such additional storage is illustrated in FIG. 9 by removable storage 508 and non-removable storage 510.

Computing device 500 typically includes a variety of computer readable media. Computer readable media can be any available media that can be accessed by device 500 and include both volatile and non-volatile media, and removable and non-removable media.

Computer storage media include volatile and non-volatile, and removable and non-removable media implemented in any method or technology for storage of information such as computer readable instructions, data structures, program modules or other data. Memory 504, removable storage 508, and non-removable storage 510 are all examples of computer storage media. Computer storage media include, but are not limited to, RAM, ROM, electrically erasable program read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store the information and which can be accessed by computing device 500. Any such computer storage media may be part of computing device 500.

Computing device 500 may contain communications connection(s) 512 that allow the device to communicate with other devices. Computing device 500 may also have input device(s) 514 such as a keyboard, mouse, pen, voice input device, touch input device, etc. Output device(s) 516 such as a display, speakers, printer, etc. may also be included. All these devices are well-known in the art and need not be discussed at length here.

Computing device 500 may be one of a plurality of computing devices 500 inter-connected by a network. As may be appreciated, the network may be any appropriate network, each computing device 500 may be connected thereto by way of communication connection(s) 512 in any appropriate manner, and each computing device 500 may communicate with one or more of the other computing devices 500 in the network in any appropriate manner. For example, the network may be a wired or wireless network within an organization or home or the like, and may include a direct or indirect coupling to an external network such as the Internet or the like.

It should be understood that the various techniques described herein may be implemented in connection with hardware or software or, where appropriate, with a combination of both. Thus, the processes and apparatus of the presently disclosed subject matter, or certain aspects or portions thereof, may take the form of program code (i.e., instructions) embodied in tangible media, such as floppy diskettes, CD-ROMs, hard drives, or any other machine-readable storage medium where, when the program code is loaded into and executed by a machine, such as a computer, the machine becomes an apparatus for practicing the presently disclosed subject matter.

In the case of program code execution on programmable computers, the computing device generally includes a processor, a storage medium readable by the processor (including volatile and non-volatile memory and/or storage elements), at least one input device, and at least one output device. One or more programs may implement or utilize the processes described in connection with the presently disclosed subject matter, e.g., through the use of an API, reusable controls, or the like. Such programs may be implemented in a high level procedural or object-oriented programming language to communicate with a computer system. However, the program(s) can be implemented in assembly or machine language. In any case, the language may be a compiled or interpreted language and it may be combined with hardware implementations.

Although exemplary implementations may refer to utilizing aspects of the presently disclosed subject matter in the context of one or more stand-alone computer systems, the subject matter is not so limited, but rather may be implemented in connection with any computing environment, such as a network or distributed computing environment. Still further, aspects of the presently disclosed subject matter may be implemented in or across a plurality of processing chips or devices, and storage may similarly be affected across a plurality of devices. Such devices might include PCs, network servers, and handheld devices, for example.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed:

1. A light-field projector (LFP) device comprising:
a solid-state LED array (SLEA) comprising a plurality of light-emitting diodes (LEDs);
a microlens array (MLA) placed at a separation distance from the SLEA, the MLA comprising a plurality of microlenses; and
a processor communicatively coupled to the SLEA and adapted to:
identify a target pixel for rendering on the retina of a human eye,
determine at least one LED from among the plurality of LEDs for displaying the pixel,
move the at least one LED to a best-fit pixel location relative to the MLA and corresponding to the target pixel, and
cause the LED to emit a primary beam of a specific intensity for a specific duration.

2. The device of claim 1, wherein the separation distance is equal to a focal length for a corresponding microlens in the MLA to enable the MLA to collimate light emitted from the SLEA through the MLA.

3. The device of claim 1, wherein the processor communicatively coupled to the SLEA is further adapted to add focus cues to the generated light field.

4. The device of claim 1, further comprising image generation based on a measured head attitude of a LFP user in order to reduce latency between a physical head motion and a generated display image.

5. The device of claim 1, wherein the pitch between each LED among the plurality of LEDs comprising the SLEA is equal to the pitch between each microlens among the plurality of microlenses comprising the MLA in order to generate an image at an infinite perceived distance.

6. The device of claim 1, wherein the pitch between a subset of LEDs among the plurality of LEDs comprising the SLEA is less than the pitch between each microlens among the plurality of microlenses comprising the MLA in order to generate visual cues for an image at a finite perceived distance.

7. The device of claim 1, wherein the processor communicatively coupled to the SLEA is further adapted to correct for imperfect vision of a user of the LFP.

8. The device of claim 1, wherein a diameter and a focal length of each microlens among the plurality of microlenses comprising the MLA is small enough to permit no more than one beam from each LED comprising the SLEA to enter the eye.

9. The device of claim 1, wherein a pixel projected onto the retina of an eye comprises primary beams from multiple LEDs from among the plurality of LEDs.

10. The device of claim 1, wherein the plurality of LEDs are mechanically multiplexed to time-sequentially produce an effect of a larger number of static LEDs.

11. The device of claim 1, wherein a light emission aperture for each LED among the plurality of LEDs is smaller than the pixel pitch.

12. The device of claim 1, wherein a subset of LEDs from among the plurality of LEDs are red LEDs, wherein a subset of LEDs from among the plurality of LEDs are green LEDs, wherein a subset of LEDs from among the plurality of LEDs are blue LEDs, and wherein a combination of LEDs from at least two of these subsets are used to render a color pixel.

13. A method for mechanically multiplexing a plurality of LEDs in a light-field projector (LFP) comprising a solid-state LED array (SLEA) having a plurality of light-emitting diodes (LEDs) and a microlens array (MLA) having a plurality of microlenses placed at a separation distance from the SLEA, the method comprising:
arranging a plurality of LEDs to achieve overlapping orbits;
identifying a best-fit pixel for each target pixel;
orbiting the LEDs; and
emitting a primary beam to at least partially render a pixel on a retina of an eye of a user when an LED is located at a best-fit pixel location for a target pixel that is to be rendered.

14. The method of claim 13, wherein the MLA structure and the SLEA structure use the same pattern.

15. The method of claim 13, wherein the arranging results in a hexagonal arrangement of the plurality of LEDs.

16. The method of claim 13, wherein the arranging is performed to achieve a 15×pitch ratio to achieve a 721:1 multiplexing ratio.

17. The method of claim 13, wherein the orbit follows a 3:5 Lissajous trajectory.

18. A computer-readable medium comprising computer-readable instructions for a light-field projector (LFP) comprising a solid-state LED array (SLEA) having a plurality of light-emitting diodes (LEDs) and a microlens array (MLA) having a plurality of microlenses placed at a separation distance from the SLEA, the computer-readable instructions comprising instructions that cause a processor to:
identify a plurality of target pixel for rendering on the retina of a human eye,
calculate the subset of LEDs from among the plurality of LEDs to be used for displaying the pixel,
mechanically multiplex the plurality of LEDs, and
cause the plurality of LED to emit a primary beam of a specific intensity for a specific duration in accordance with best-fit pixel location relative to the MLA and corresponding to the target pixel.

19. The computer-readable medium of claim 18, further comprising instructions for causing the processor to add finite focus cues to the rendered image.

20. The computer-readable medium of claim 18, further comprising instructions for sensing the position of each rendered beam on the retina of the eye from the light that is reflected back towards the SLEA.
